(19) United States
(12) Patent Application Publication
(10) Pub. No.: US 2012/0296947 A1
(43) Pub. Date: Nov. 22, 2012

(54) FILE MANAGEMENT APPARATUS AND COMPUTER-READABLE RECORDING MEDIUM

(75) Inventor: Satoru GOTO, Nagoya-shi (JP)

(73) Assignee: Buffalo Inc., Nagoya-shi (JP)

(21) Appl. No.: 13/475,428

(22) Filed: May 18, 2012

(30) Foreign Application Priority Data
May 19, 2011 (JP) 2011-112920

(51) Int. Cl. G06F 17/30; G06F 15/16

(52) U.S. Cl. 707/827; 707/E17.032

(57) ABSTRACT

A file management apparatus including a network interface that receives a storage request to store a file. A processor of the file management apparatus then controls uploading the file to an online storage in response to the storage request, and controls providing a continuous display indicating that a process for storing the file into the file management apparatus is being carried out until the upload of the file to the online storage is completed.

### CROSS-REFERENCE TO RELATED APPLICATION

This non-provisional application claims priority under 35 U.S.C. §119(a) to Japanese Patent Application No. 2011-112920 filed on May 19, 2011, the entire contents of which are hereby incorporated by reference.

### BACKGROUND OF THE DISCLOSURE

1. Field of the Disclosure

The present disclosure relates to a file management apparatus and a computer-readable recording medium compatible with online storage services.

2. Description of the Related Art

There exist local storage arrangements such as storage devices incorporated in users' terminals (called the user terminal hereunder) and external storage devices to be connected to the user terminal, the devices being configured to store various files.

Progress in communication technology in recent years has given birth to online services (Web services) offering to store files in an online storage on the Internet. With such services, the user terminal uploads and downloads files to and from the online storage.

In order to enhance the availability of such online storage, there has been proposed a file management apparatus offering an experience in which a user is led to utilize an online storage without becoming aware of it (see Japanese Patent Laid-open No. 2010-287104).

The file management apparatus proposed in the above-cited Japanese Patent Laid-open No. 2010-287104 includes an application for automatically uploading the files held in the apparatus to an online storage. The proposed apparatus presents the user with a display of virtual files indicating as if the files are held inside the apparatus although they are actually in the online storage.

The file management apparatus described in the above-cited Japanese Patent Laid-open No. 2010-287104 is configured to handle the online storage as a local storage. This configuration has the following problem.

For example, when the user thinks that a given file has been copied to the file management apparatus, that file is in fact uploaded (i.e., transferred) to the online storage. In such a case, the user may delete the source file mistakenly believing that the process of storing it into the file management apparatus is completed though it is not actually completed.

The inadvertent erasure of the file can take place because the upload to the online storage may fail due to service constraints or poor status of communication lines. If the source file is deleted and if the upload of that file to online storage fails, the file itself disappears.

The present disclosure has been made in view of the above circumstances and provides a file management apparatus and a computer-readable recording medium for resolving the above-mentioned and other problems that may be encountered when an online storage is handled as a local storage.

### SUMMARY OF THE DISCLOSURE

There is provided a file management apparatus including a network interface that receives a storage request to store a file. A processor of the file management apparatus then controls uploading the file to an online storage in response to the storage request, and controls providing a continuous display indicating that a process for storing the file into the file management apparatus is being carried out until the upload of the file to the online storage is completed.

### BRIEF DESCRIPTION OF THE DRAWINGS

Further objects and advantages of the present disclosure will become apparent upon a reading of the following description and appended drawings in which:

FIG. 1 is an overall configuration diagram of a communication system as one aspect of the present disclosure;

FIG. 2 is a hardware configuration diagram of a NAS (Network Attached Storage) according to one aspect of the disclosure;

FIG. 3 is a functional block diagram of the NAS according to one aspect of the disclosure;

FIG. 4 is a schematic view showing a typical directory structure managed by a file management part;

FIG. 5 is an operating sequence diagram of a successful upload performed by the communication system as one aspect of the disclosure;

FIG. 6 is an operating sequence diagram of a failed upload performed by the communication system as one aspect of the disclosure;

FIG. 7 is an overall configuration diagram of a communication system as another aspect of the disclosure;

FIG. 8 is an operating sequence diagram of a successful upload performed by the communication system as another aspect of the disclosure; and

FIG. 9 is an operating sequence diagram of a failed upload performed by the communication system as another aspect of the disclosure.

### DETAILED DESCRIPTION

Some preferred aspects of the present disclosure are described below in reference to the accompanying drawings. The file management apparatus for each of the preferred aspects of the disclosure discussed hereunder may be a NAS (Network Attached Storage), for example. In the ensuing description, like or corresponding parts and components are designated by like or corresponding reference symbols.

### (System Configuration)

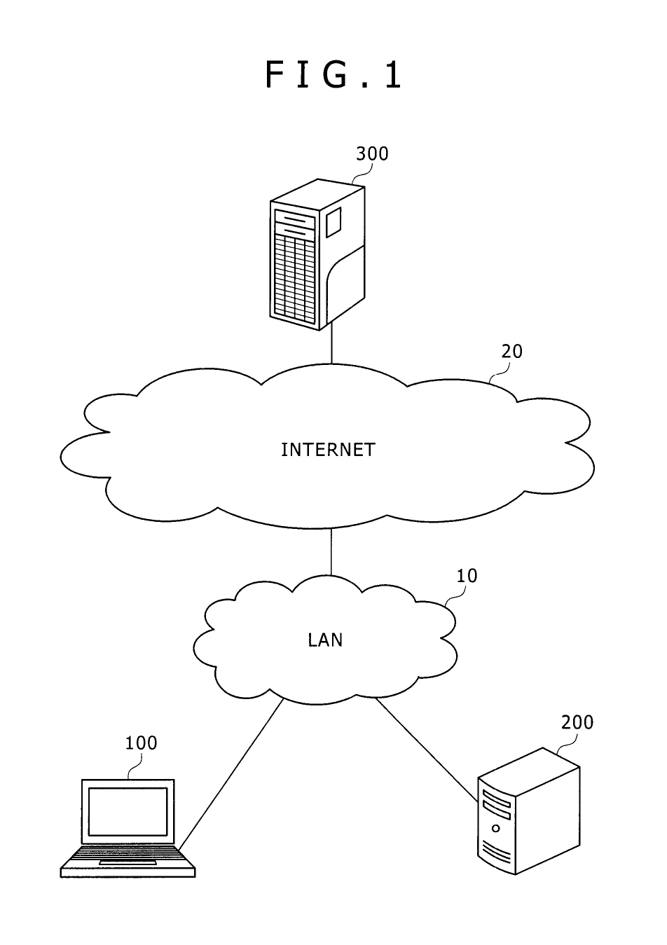

An overall configuration of a communication system 1 as one aspect of the present disclosure will now be explained. FIG. 1 is an overall configuration diagram of the communication system 1 as one aspect of this disclosure.

As shown in FIG. 1, the communication system 1 includes has a PC 100, a NAS 200, and an online storage 300. In this aspect, the PC 100 corresponds to a user terminal. Although the PC 100 acting as the user terminal here is a personal computer, the user terminal may also be a mobile phone terminal, a network-ready TV set or the like.

The PC 100 and NAS 200 are connected to a LAN (Local Area Network) such as a home network, and communicate with each other via the LAN 10. The LAN 10 is connected to the Internet 20 via a router or the like. The online storage 300 is connected to the Internet 20.

The PC 100 is an information processing apparatus operated by a user and furnished with a network communication function for conducting network communications and with a user interface (including a display, a keyboard, a mouse, etc.). The PC 100 writes and reads files to and from the NAS 200 via the LAN 10.

The NAS 200 is a file server that stores and manages files. A file system is formed in the NAS 200 for file management purposes. Also, the NAS 200 includes a network communication function for carrying out network communications. The NAS 200 may be shared by a plurality of user terminals.

The online storage 300 offers a Web service that stores files, and is configured with one or a plurality of file servers. For example, the online storage 300 offers a storage area that can be used by a user of the PC 100 having registered with its Web service. For this aspect of the disclosure, the user of the PC 100 is assumed to have registered with the service offered by the online storage 300.

### (NAS Configuration)

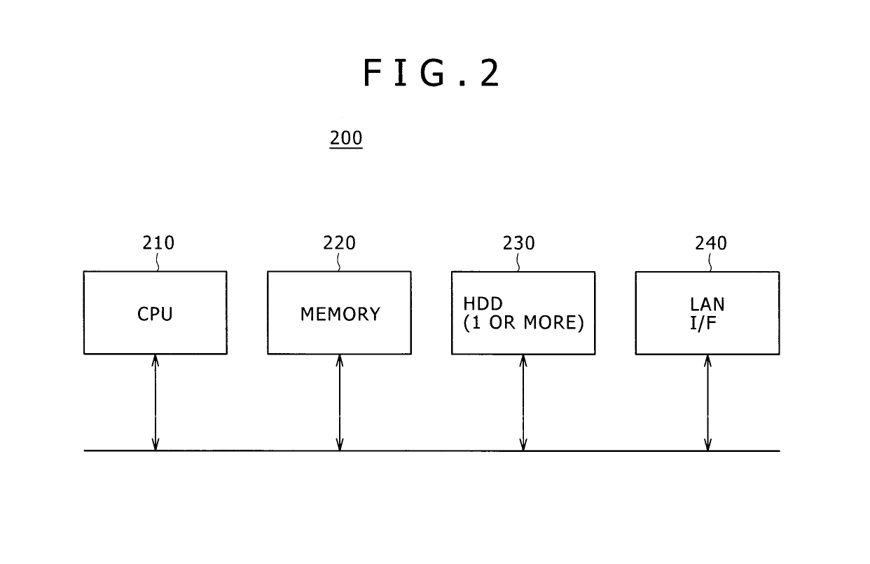

The hardware configuration of the NAS 200 is explained below. FIG. 2 is a hardware configuration diagram of the NAS 200.

As shown in FIG. 2, the NAS 200 has a CPU (Central Processing Unit) 210, a memory 220, one or a plurality of HDDs (Hard Disk Drives) 230, and a LAN interface 240. The CPU 210, memory 220, HDDs 230, and LAN interface 240 are interconnected via a bus line.

The CPU 210 executes control programs that are stored in the memory 220. Specific operations of the CPU 210 will be discussed later.

The memory 220 includes a nonvolatile memory such as a flash memory. Alternatively, the memory 220 may include a volatile memory such as a RAM (Random Access Memory) in addition to the nonvolatile memory. The memory 220 stores in its nonvolatile memory (e.g., flash memory) the control programs to be executed by the CPU 210. Also, the memory 220 temporarily accommodates in its RAM or the like the control programs read from the nonvolatile memory. Furthermore, the memory 220 is used by the CPU 210 as a work area.

In this aspect of the disclosure, the memory 220 includes a cache area for caching the files to be uploaded to and downloaded from the online storage 300.

The HDDs 230 store diverse files. The HDDs 230 may be configured to make up a disk array or a RAID (Redundant Arrays of Inexpensive Disks).

The LAN interface 240 is connected to the LAN 10 and configured to conduct communications via the LAN 10. The LAN interface 240 may be connected to the LAN 10 in either wired or wireless fashion.

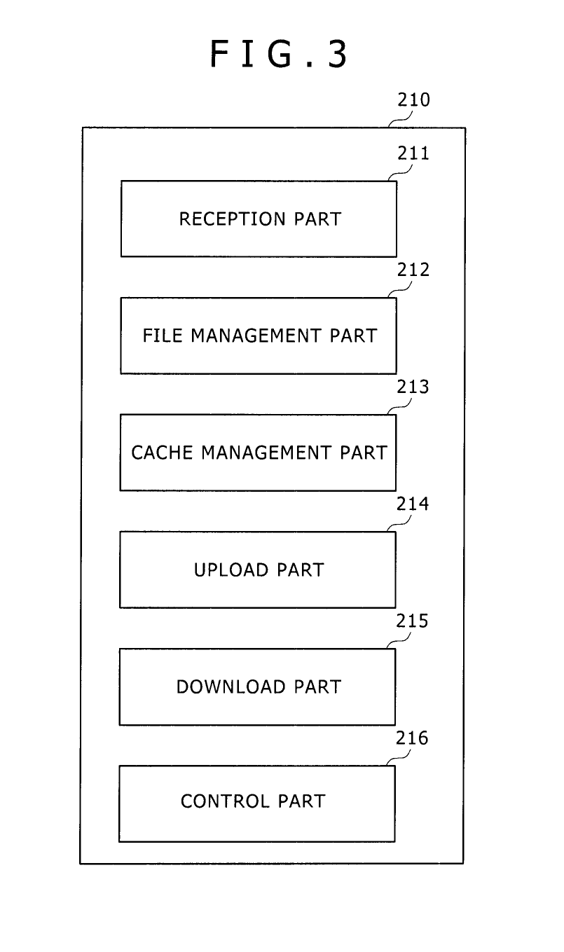

The functional structure of the NAS 200 is explained below. FIG. 3 is a functional block diagram of the NAS 200 according to this aspect of the disclosure.

As shown in FIG. 3, the CPU 210 carries out the control programs held in the memory 220 to implement such functional parts as a reception part 211, a file management part 212, a cache management part 213, an upload part 214, a download part 215, and a control part 216.

The reception part 211 receives a file storage request and a file readout request input from the PC 100 via the LAN 10 and LAN interface 240.

The file management part 212 corresponds to the file system. The file management part 212 provides a hierarchically structured file system that includes a plurality of folders (directories). Some of the folders (directories) contain the substance of the files stored in the NAS 200; other folders (directories) are provided to look as if the folders (directories) in the online storage 300 exist virtually on the local side (i.e., in the NAS 200). A specific example of the directory structure will be discussed later.

The cache management part 213 performs a process for caching files in the cache area in the memory 220 before they are uploaded to the online storage 300 or after they are downloaded therefrom.

Specifically, when a file to be uploaded (called the storage target file) starts getting stored (cached) into the cache area of the memory 220, the cache management part 213 uploads the file in question to the online storage 300 instantaneously (synchronously). In other words, the cache management part 213 instructs the upload part 214 to upload the storage target file to the online storage 300 in parallel with the caching of the file.

For example, if possible, the cache management part 213 starts uploading the storage target file before completion of the caching of the entire file to be uploaded. If the file size of the storage target file can be obtained, the cache management part 213 determines that the file in question can be cached and uploaded at the same time and thus instructs the upload part 214 to start uploading the file before completion of the caching of the whole file to be uploaded. If the file size of the storage target file cannot be obtained or if it is otherwise determined impossible to cache and upload the file at the same time, the cache management part 213 instructs the upload part 214 to start uploading the storage target file after completion of the caching of the entire file in question. In this manner, where the storage target file is to be uploaded after completion of the caching of the entire file, the cache management part 213 may instruct the upload part 214 to start uploading the storage target file as soon as the caching of the entire file in question is completed.

Given a file storage request received by the reception part 211, the upload part 214 uploads the storage target file to the online storage 300. Specifically, in response to the receipt by the reception part 211 of the file storage request to store the target file into a virtual local directory managed by the file management part 212, the upload part 214 uploads the storage target file to the online storage 300. As explained above, when instructed by the cache management part 213 to upload the file, the upload part 214 performs the upload in parallel with the caching process (i.e., synchronous upload).

Given a file readout request received by the reception part 211, the download part 215 downloads a readout target file from the online storage 300. Specifically, in response to the receipt by the reception part 211 of the file readout request to read the file in question from the virtual local directory managed by the file management part 212, the download part 215 downloads the readout target file from the online storage 300.

The control part 216 performs a process for causing the PC 100 to give a continuous display indicating that the process of storing the target file into the NAS 200 is underway until completion of the upload of the file to the online storage 300. Specifically, the PC 100 of this aspect of the disclosure displays information as instructed by the NAS 200. The information may be provided as a Web page for example, and may be displayed by a browser on the PC 100.

In this aspect of the disclosure, the control part 216 performs control not to notify the PC 100 that the process of storing the file into the NAS 200 is completed until receipt of notification from the online storage 300 that the upload thereto is completed. For example, if information is provided in the form of a Web page, the control part 216 gives a continuous display indicating that the file is being stored until receipt of notification from the online storage 300 that the upload is completed. Also, upon receipt of notification from the online storage 300 that the upload thereto has failed, the control part 216 notifies the PC 100 that the process of storing the target file into the NAS 200 has failed.

Furthermore, until completion of the download of the target file from the online storage 300, the control part 216 gives a continuous display indicating that the process of reading the file in question from the NAS 200 is underway. For example, if the NAS 200 provides a Web page to the PC 100, the control part 216 gives a continuous display indicating that the target file is being read until receipt of notification from the online storage 300 that the download therefrom is completed.

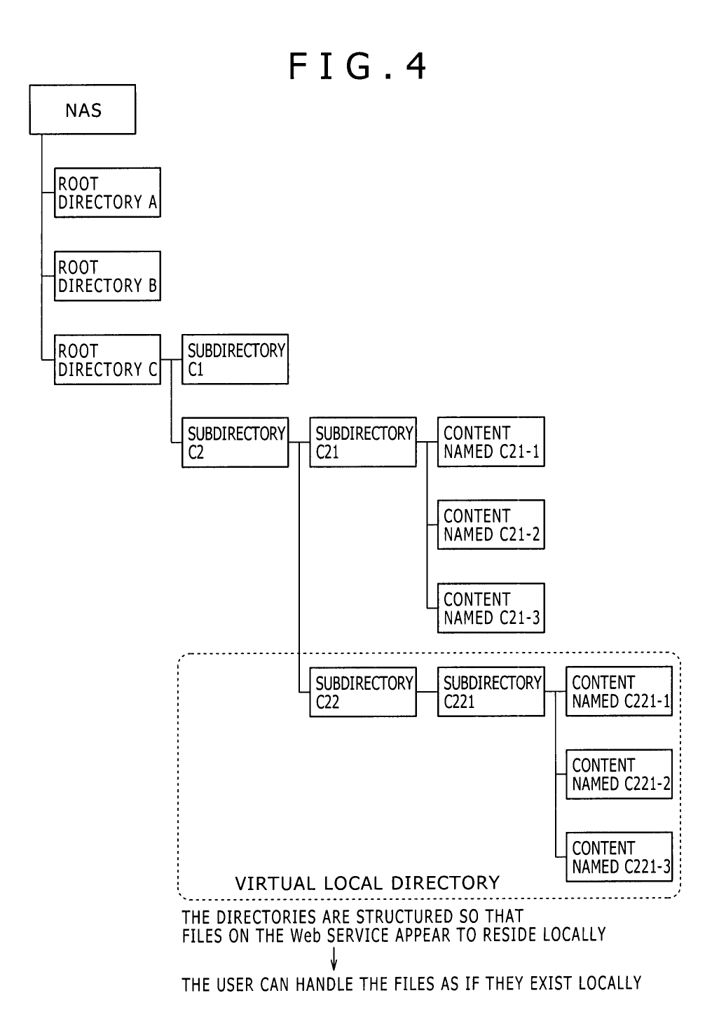

A specific example of the directory structure managed by the file management part 212 is explained below. FIG. 4 is a schematic view showing a typical directory structure managed by the file management part 212.

As shown in FIG. 4, the typical directory structure of this aspect of the disclosure includes root directories A through C. Subdirectories C1 and C2 are formed under the root directory C, and subdirectories C21 and C22 are placed subordinate to the subdirectory C2.

The substance of the files included in the subdirectory C21 (contents C21-1 through C21-3) is stored in the NAS 200. By contrast, the substance of the files included in the subdirectory C22 (i.e., subdirectory C221; contents C221-1 through C221-3) is stored in the online storage 300. If requested by the PC 100 to provide a list of files that may be in the subdirectory C21, the file management part 212 of the NAS 200 offers the PC 100 a list of the files included in the subdirectory C21 (contents C21-1 through C21-3).

If requested by the PC 100 to provide a list of files that may be in the subdirectory C22, the file management part 212 offers the PC 100 a list of the files included in the subdirectory C22 (contents C221-1 through C221-3).

As described above, although the directories subordinate to the subdirectory C22 are handled as if the files therein exist in the NAS 200, the substance of these files is in fact stored in the online storage 300. As such, the subdirectory C22 is configured as a virtual local directory. Thus upon receipt of a request to store a file into a virtual local directory (e.g., subdirectory C22 in this case), the NAS 200 uploads the file requested to be uploaded to the corresponding directory in the online storage 300. Also, upon receiving a request to read a file from the virtual local directory (subdirectory C22), the NAS 200 downloads the file requested to be downloaded from the corresponding directory in the online storage 300 and offers the downloaded file to the requesting terminal.

The above-described virtual local directory may be configured using software such as FUSE (Filesystem in Userspace) with which a file system can be organized.

### (System Operations)

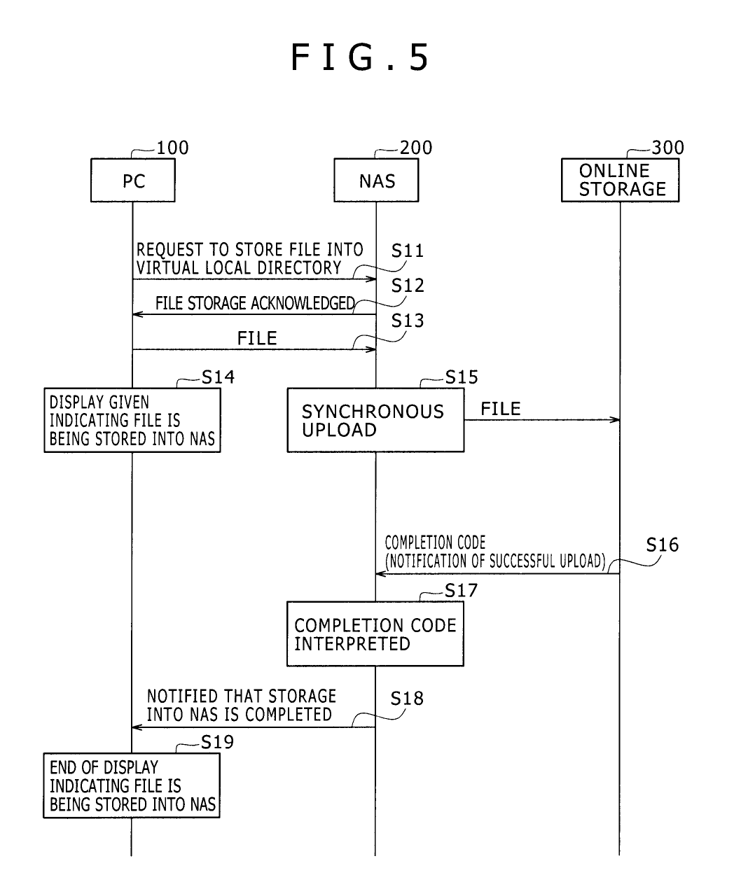

The operations of the communication system 1 as one aspect of the present disclosure are explained below. FIG. 5 is an operating sequence diagram of a successful upload performed by the communication system 1 embodying this disclosure.

As shown in FIG. 5, in step S11, the PC 100 transmits to the NAS 200 a request to store a file into a virtual local directory among the directories managed by the NAS 200. The NAS 200 receives the file storage request.

In step S12, the NAS 200 transmits to the PC 100 an acknowledge signal in response to the file storage request. The PC 100 receives the acknowledge signal.

In step S13, the PC 100 starts transferring to the NAS 200 the storage target file corresponding to the file storage request.

In step S14, after starting to transfer the storage target file, the PC 100 starts giving a display indicating that the file in question is being stored into the virtual local directory of the NAS 200. For example, information to that effect may be offered by a Web page and displayed by a browser on the PC 100.

In step S15, the NAS 200 performs a synchronous upload of the storage target file transferred from the PC 100. That is, the NAS 200 uploads the storage target file to the online storage 300 in parallel with the process of caching the file in question. Upon receipt of the storage target file, the online storage 300 determines whether the target file satisfies the constraints of the service. Determining whether the constraints are met involves verifying if the type and size of the file satisfy predetermined conditions, for example. For purpose of explanation here, the storage target file is assumed to meet the constraints of the service.

In step S16, the online storage 300 transmits to the NAS 200 a completion code indicating that the storage of the target file is completed. The NAS 200 receives the completion code. Giving the completion code saying that the storage of the file in question is completed is equivalent to giving notification that the upload to the online storage 300 is completed (i.e., successful upload).

In step S17, the NAS 200 interprets the completion code received from the online storage 300. That is, the NAS 200 translates the notification from the online storage 300 that the upload thereto is completed into a notification that the process of storing the target file into the virtual local directory of the NAS 200 is completed.

In step S18, the NAS 200 transmits to the PC 100 the notification that the process of storing the target file into the virtual local directory of the NAS 200 is completed (called the storage complete response). The PC 100 receives the storage complete response.

As explained above, the NAS 200 does not notify the PC 100 that the process of storing the target file into the NAS 200 is completed until receipt from the online storage 300 of the notification that the upload thereto is completed.

In step S19, upon receipt of the storage complete response from the NAS 200, the PC 100 stops giving the display indicating that the storage target file is being stored into the virtual local directory of the NAS 200. While the target file is being stored into the NAS 200, the PC 100 performs controls to inhibit operations on the target file that is resident in the PC 100.

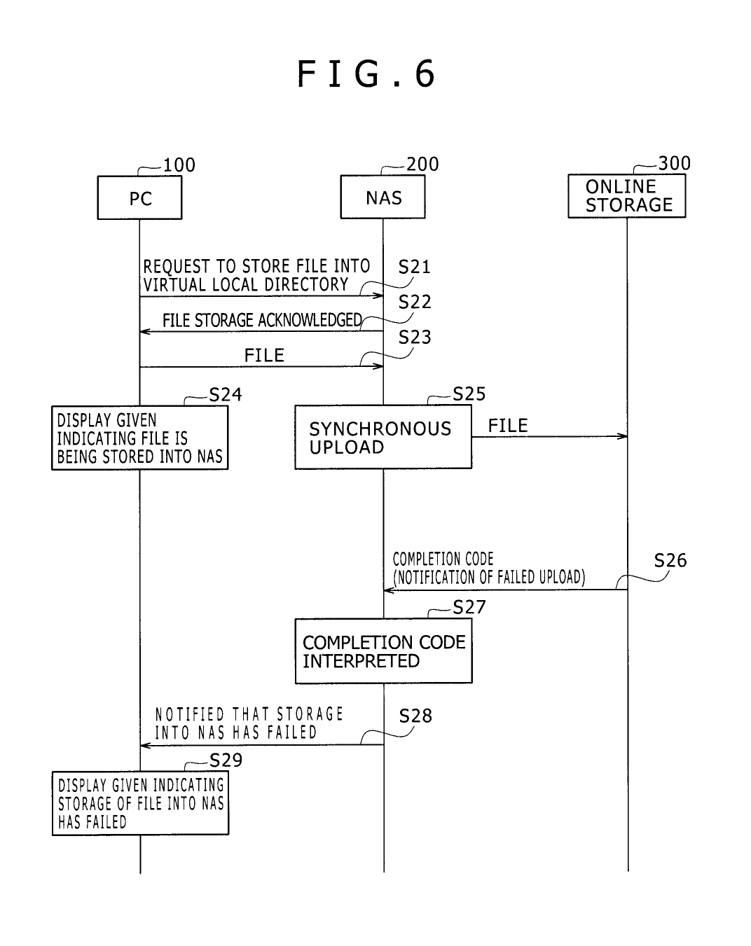

Explained below is a case in which the communication system 1 as one aspect of the disclosure carries out an unsuccessful upload. FIG. 6 is an operating sequence diagram of a failed upload performed by the communication system 1 embodying the disclosure.

Steps S21 through S24 in FIG. 6 are the same as steps S11 through S14 discussed above and thus will not be explained further.

In step S25, the NAS 200 performs a synchronous upload of the storage target file transferred from the PC 100. That is, the NAS 200 uploads the target file to the online storage 300 in parallel with the process of caching the file in question. Upon receipt of the storage target file, the online storage 300 determines whether the file in question satisfies the constraints of the service. It is assumed here that the file in question does not meet the constraints of the service.

In step S26, the online storage 300 transmits to the NAS 200 a completion code indicating that the storage of the target file is not completed. The NAS 200 receives the completion code. Giving the completion code saying that the storage of the file in question is not completed is equivalent to giving notification that the upload to the online storage 300 has failed.

In step S27, the NAS 200 interprets the completion code received from the online storage 300. That is, the NAS 200 translates the notification from the online storage 300 that the upload thereto has failed into a notification that the process of storing the target file into the virtual local directory of the NAS 200 has failed.

In step S28, the NAS 200 transmits to the PC 100 a notification that the process of storing the target file into the virtual local directory of the NAS 200 has failed (called the save failure response). The PC 100 receives the save failure response.

As explained above, given from the online storage 300 the notification that the upload thereto has failed, the NAS 200 notifies the PC 100 that the process of storing the target file into the NAS 200 has failed.

In step S29, upon receipt of the save failure response from the NAS 200, the PC 100 gives a display indicating that the storage of the target file into the virtual local directory of the NAS 200 has failed.

In the operating sequence in FIG. 6, the NAS 200 may retry the upload upon receipt of the completion code saying that the storage of the file into the online storage 300 has failed. The retry attempt helps increase the possibility of a successful upload.

In the operating sequence in FIG. 5, upon receipt of the completion code saying that the storage of the target file into the online storage 300 is successful, the NAS 200 may verify whether the upload has been done correctly. For example, the NAS 200 may compare the target file in the online storage 300 with the corresponding file in the NAS 200 to see if they coincide with each other. The verification helps increase the reliability of the upload. The verification may be carried out by comparing the hash values of the files involved.

### (Effects)

According to this aspect of the disclosure, as explained above, the NAS 200 performs control to have the PC 100 give a continuous display indicating that the process of storing the target file into the NAS 200 is underway until completion of the upload to the online storage 300. This allows the user to recognize that the process of storing the file into the NAS 200 is in progress until completion of the upload to the online storage 300. The user is thus prevented from inadvertently deleting the copy source file before the upload thereof is completed.

Also according to this aspect of the disclosure, the NAS 200 performs the upload in synchronism with the caching process (i.e., synchronous upload). This shortens the time it takes to complete the upload and forestalls a prolonged wait time.

According to this aspect of the disclosure, the NAS 200 does not notify the PC 100 that the process of storing the file into the NAS 200 is completed until receipt from the online storage 300 of the notification that the upload thereto is completed. Thus, the PC 100 is allowed to give a continuous display indicating that the process of storing the file into the NAS 200 is underway until completion of the upload to the online storage 300. That is, upon transmitting a file storage request to the NAS 200, the PC 100 gives a display indicating that a file storing process is underway (e.g., a message saying “file is being saved”). Upon receipt of notification from the NAS 200 that the file storing process is completed, the PC 100 stops giving the display saying that the file storing process is in progress.

Alternatively, the PC 100 may display the Web page offered by the NAS 200. The PC 100 may update the displayed Web page repeatedly at predetermined intervals. In this case, while exercising control to continue the display indicating that the file storing process is underway, the NAS 200 gives the display saying that the file storing process is in progress.

According to this aspect of the disclosure, when notified by the online storage 300 of a failed upload thereto, the NAS 200 notifies the PC 100 that the process of storing the target file into the NAS 200 has failed. This allows the user to recognize the failed upload to the online storage 300 as a failure to store the file into the NAS 200.

According to this aspect of the disclosure, the NAS 200 performs file management using a directory structure in which virtual local directories representative of directories in the online storage 300 are provided as part of the directories making up the file system of the NAS 200.

According to this aspect of the disclosure, upon receipt of a request to store a file into a virtual local directory, the NAS 200 uploads the file in question to the online storage 300. In this manner, the file to be stored into the virtual local directory can be uploaded to the online storage 300 without the intervention of the user explicitly performing operations for the purpose.

According to this aspect of the disclosure, the NAS 200 performs control to have the PC 100 give a continuous display indicating that a file is being read from the NAS 200 until completion of the download of the file in question from the online storage 300. In this manner, the user is allowed to recognize that the file is being read from the NAS 200 until completion of the download of the file in question from the online storage 300.

### (Modifications)

Although the description made above in reference to the accompanying drawings contains specificity, these should not be construed as limiting the scope of the disclosure but as merely providing illustrations of one aspect of this disclosure. It is evident that many alternatives, modifications and variations will become apparent to those skilled in the art in light of the foregoing description.

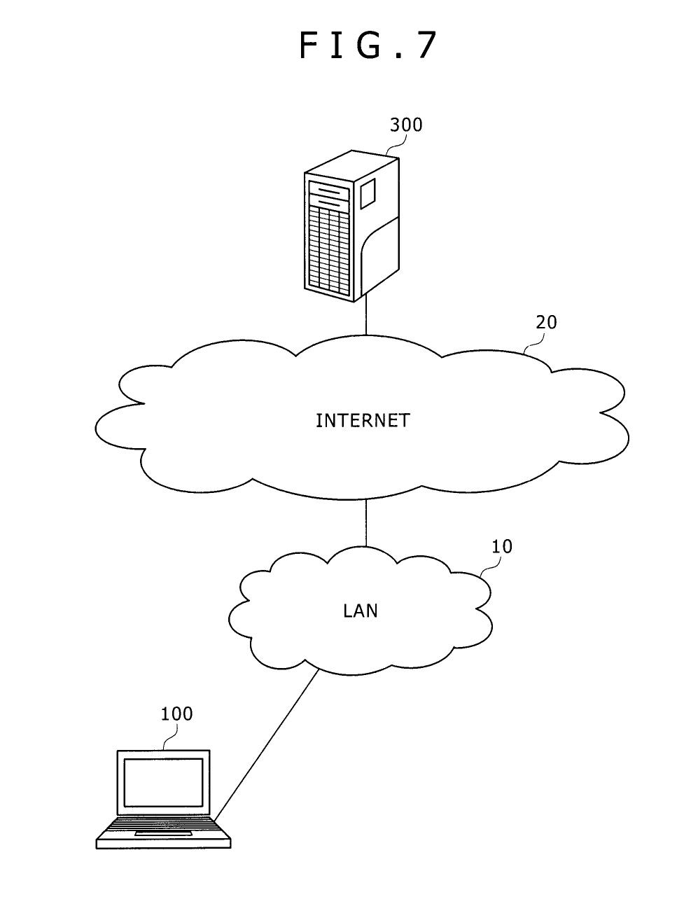

For example, the above-described aspect of this disclosure is the NAS 200 acting as the file management apparatus. Alternatively, another aspect of the disclosure may be the PC 100 acting as the file management apparatus. FIG. 7 is an overall configuration diagram of a communication system 1 as another aspect of the present disclosure.

As shown in FIG. 7, the communication system 1 alternatively embodying this disclosure does not include the NAS 200. In this aspect of the disclosure, the PC 100 corresponds to the file management apparatus. The PC 100 has substantially the same hardware configuration as that shown in FIG. 2 and the same functional structure as that shown in FIG. 3.

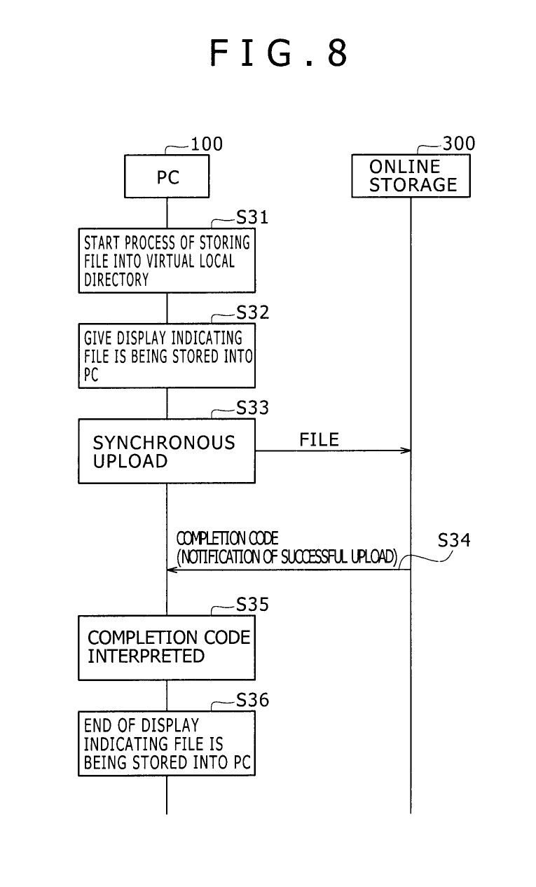

Explained below is how the communication system 1 operates as the alternative aspect of the disclosure. FIG. 8 is an operating sequence diagram of a successful upload performed by the communication system 1 alternatively embodying the present disclosure.

As shown in FIG. 8, in step S31, the user of the PC 100 performs operations to store a file (i.e., makes a file storage request) into a virtual local directory among the directories managed by the PC 100. The PC 100 starts the process of storing the target file into the virtual local directory.

In step S32, the PC 100 starts a display indicating that the storage target file is being stored into the virtual local directory of the PC 100.

In step S33, the PC 100 performs a synchronous upload of the storage target file. That is, the PC 100 uploads the target file to the online storage 300 in parallel with the process of caching the file in question. The online storage 300 receives the storage target file and determines whether the target file satisfies the constraints of the service. It is assumed here that the storage target file meets the constraints of the service.

In step S34, the online storage 300 transmits to the PC 100 a completion code indicating that the storage of the target file is completed. The PC 100 receives the completion code. Giving the completion code saying that the storage of the file in question is completed is equivalent to giving notification that the upload to the online storage 300 is completed (i.e., successful upload).

In step S35, the PC 100 interprets the completion code received from the online storage 300. That is, the PC 100 interprets the notification from the online storage 300 that the upload thereto is completed as a notification that the process of storing the target file into the virtual local directory of the PC 100 is completed.

In step S36, the PC 100 terminates the display indicating that the storage target file is being stored into the virtual local directory of the PC 100.

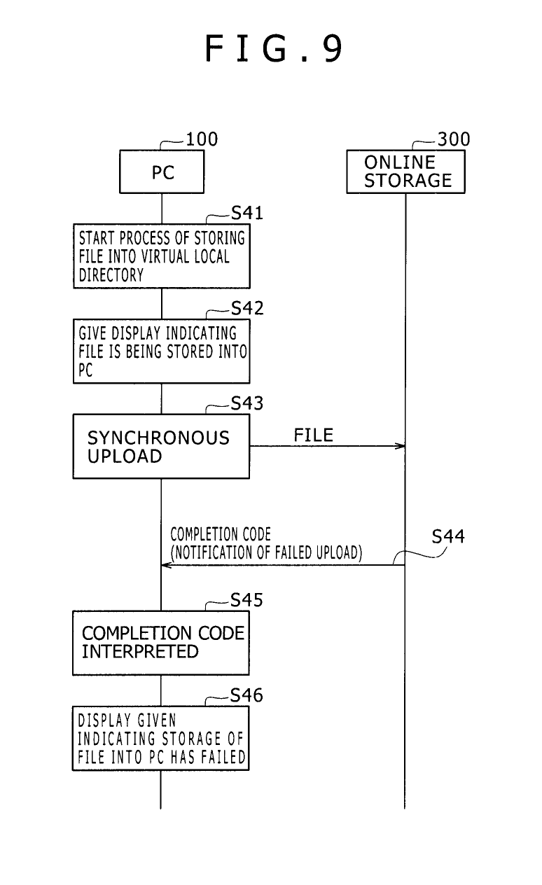

FIG. 9 is an operating sequence diagram of a failed upload performed by the communication system 1 as the alternative aspect of the disclosure.

Steps S41 and S42 in FIG. 9 are the same as steps S31 and S32 discussed above and thus will not be explained further.

In step S43, the PC 100 performs a synchronous upload of the storage target file. That is, the PC 100 uploads the target file to the online storage 300 in parallel with the process of caching the file in question. The online storage 300 receives the storage target file and determines whether the target file satisfies the constraints of the service. It is assumed here that the storage target file does not meet the constraints of the service.

In step S44, the online storage 300 transmits to the PC 100 a completion code indicating that the storage of the target file is not completed. The PC 100 receives the completion code. Giving the completion code saying that the storage of the file in question is not completed is equivalent to giving notification that the upload to the online storage 300 has failed.

In step S45, the PC 100 interprets the completion code received from the online storage 300. That is, the PC 100 interprets the notification from the online storage 300 that the upload thereto has failed as a notification that the process of storing the target file into the virtual local directory of the PC 100 is unsuccessful.

In step S46, the PC 100 gives a display indicating that the storage of the target file into the virtual local directory of the PC 100 has failed.

Thus while the present disclosure is described in terms of preferred or exemplary embodiments, it is not limited thereto, and the scope of the disclosure should be determined by the appended claims and their legal equivalents, rather than by the examples given.

What is claimed is:

1. A file management apparatus comprising:
a network interface that receives a storage request to store a file; and
a processor that:
controls uploading said file to an online storage in response to said storage request; and
controls providing a continuous display indicating that a process for storing said file into said file management apparatus is being carried out until the upload of said file to said online storage is completed.

2. The file management apparatus according to claim 1, wherein
the processor controls uploading said file to said online storage in synchronism with a process for caching said file to be uploaded to said online storage.

3. The file management apparatus according to claim 1, wherein
said network interface receives said storage request to store said file from a user terminal via a network.

4. The file management apparatus according to claim 3, wherein
said processor controls not notifying said user terminal that the process for storing said file into said file management apparatus is completed until said processor receives a notification from said online storage that the upload of said file to said online storage is completed.

5. The file management apparatus according to claim 3, wherein
if notified by said online storage that the upload of said file to the online storage has failed, said processor controls notifying said user terminal that the process for storing said file into said file management apparatus has failed.

6. The file management apparatus according to claim 1, wherein
said processor performs file management using a directory structure in which a virtual local directory corresponding to a directory in said online storage is placed subordinate to a directory in said file management apparatus.

7. The file management apparatus according to claim 6, wherein
when said network interface receives said storage request to store said file into said virtual local directory, said upload part uploads said file to said online storage.

8. A computer-readable recording medium storing a program for causing a computer to perform a procedure comprising:
receiving a storage request to store a file;
uploading said file to an online storage in response to said storage request; and
exercising control to provide a continuous display indicating that a process for storing said file into a file management apparatus is being carried out until the upload of said file to said online storage is completed.

9. The computer-readable recording medium according to claim 8, wherein said procedure further comprises:
exercising control to upload said file to said online storage in synchronism with a process for caching said file to be uploaded to said online storage.

10. The computer-readable recording medium according to claim 8, wherein
said receiving includes receiving said storage request to store said file from a user terminal via a network.

11. The computer-readable recording medium according to claim 10, wherein
said exercising control includes performing control not to notify said user terminal that the process for storing said file into said file management apparatus is completed until receiving a notification that the upload of said file to the online storage is completed.

12. The computer-readable recording medium according to claim 10, wherein
if notified by said online storage that the upload of said file to the online storage has failed, said exercising control includes notifying said user terminal that the process for storing said file into said file management apparatus has failed.

13. The computer-readable recording medium according to claim 8, wherein said procedure further comprises:
performing file management using a directory structure in which a virtual local directory corresponding to a directory in said online storage is placed subordinate to a directory in said file management apparatus.

14. The computer-readable recording medium according to claim 13, wherein
upon receipt of said storage request to store said file into said virtual local directory, said uploading includes uploading said file to said online storage.

15. A method performed by a file management apparatus, the method comprising:
receiving, at a network interface of the file management apparatus, a storage request to store a file;
uploading, under the control of a processor of the file management apparatus, said file to an online storage in response to said storage request; and
exercising control, by the processor, to provide a continuous display indicating that a process for storing said file into a file management apparatus is being carried out until the upload of said file to said online storage is completed.

16. The method according to claim 15, further comprising:
exercising control, by the processor, to upload said file to said online storage in synchronism with a process for caching said file to be uploaded to said online storage.

17. The method according to claim 15, wherein
said receiving includes receiving said storage request to store said file from a user terminal via a network, and
said exercising control includes performing control not to notify said user terminal that the process for storing said file into said file management apparatus is completed until receiving a notification that the upload of said file to the online storage is completed.

18. The method according to claim 15, wherein
said receiving includes receiving said storage request to store said file from a user terminal via a network, and
if notified by said online storage that the upload of said file to the online storage has failed, said exercising control includes notifying said user terminal that the process for storing said file into said file management apparatus has failed.

19. The method according to claim 15, further comprising:
performing, by the processor, file management using a directory structure in which a virtual local directory corresponding to a directory in said online storage is placed subordinate to a directory in said file management apparatus.

20. The method according to claim 19, wherein
upon receipt of said storage request to store said file into said virtual local directory, said uploading includes uploading said file to said online storage.
